(19) United States
(12) Patent Application Publication
(10) Pub. No.: US 2012/0036088 A1
(43) Pub. Date: Feb. 9, 2012

(54) Price display apparatus having bistable display panel and method thereof

(76) Inventor: Kai-Cheng Chuang, Hsinchu City (TW)

(21) Appl. No.: 12/927,967

(22) Filed: Nov. 29, 2010

(30) Foreign Application Priority Data
Aug. 4, 2010 (TW) 99126002

(51) Int. Cl. G06Q 30/00; G09F 9/30

(52) U.S. Cl. 705/400; 40/447

(57) ABSTRACT

The configurations of a price display apparatus and a method thereof are provided in the present invention. The proposed price display apparatus includes a bistable display panel displaying a selling price of an item.

### FIELD OF THE INVENTION

The application claims the benefit of Taiwan Patent Application No. 099126002, filed on Aug. 4, 2010, in the Taiwan Intellectual Property Office, the disclosures of which are incorporated herein in their entirety by reference.

The present invention relates to a price display apparatus. More particularly, it relates to a price display apparatus having a bistable display panel and displaying one of a first selling price at a first selling status and a second selling price at a second selling status.

### BACKGROUND OF THE INVENTION

The employments of price display apparatuses (e.g., a vendor machine and a fare display of a parking lot) are getting more and more popular nowadays. The vendor machines are used for selling items such as drinks and foods and set up at various public places to facilitate people in buying the required item at any time. For example, FIG. 1 is a vendor machine in the prior art, and the vendor machine 1 includes a vendor machine main body 10, a plurality of price labels 101 (they are, e.g., written labels), and a plurality of buttons 102. The Parking lots provide parking spaces to the public, so people could enjoy the convenience of parking by paying the fare. Both the vendor machine and the parking lot are highly related to people's daily life. However, the aforementioned price currently display apparatuses display fixed prices only, and the displayed prices can not be adjusted temporarily according to the change of the requirements. For example, the selling prices of items in vendor machines should be adjusted according to the peak and the non-peak periods of the selling amount during the day so as to better reflecting the proper relations between the price, and the supply and demand of commercial transactions. For certain parking lots, the fare of which needs to be adjusted during certain period (e.g., a computer exposition is held nearby, and the parking spaces are badly needed), the adjusted fare even needs to be written on the plastic board to inform the public in some cases, and this is really quite inconvenient. If the features of the bistable display could be incorporated into the price display apparatuses so as to temporarily display the selling price of the items, then this will bring great convenient to the public.

Keeping the drawbacks of the prior arts in mind, and employing experiments and research full-heartily and persistently, the applicant finally conceived a price display apparatus having a bistable display panel and a method thereof.

### SUMMARY OF THE INVENTION

It is therefore an object of the present invention to provide a price display apparatus having a bistable display panel, displaying one of a first selling price at a first selling status and a second selling price at a second selling status, possessing a multi-advantage and being quite convenient.

According to the first aspect of the present invention, a price display apparatus includes a bistable display panel displaying a selling price of an item.

According to the second aspect of the present invention, a price display apparatus includes a display panel displaying one of a first price under a first status and a second price under a second status, for an item.

According to the third aspect of the present invention, a method for displaying a price of an item includes steps of: displaying a peak value of the price when a selling amount of the item during a specific period is larger than a predetermined value; and displaying a non-peak value of the price when the selling amount is not larger than the predetermined value.

The present invention may best be understood through the following descriptions with reference to the accompanying drawings, in which:

### BRIEF DESCRIPTION OF THE DRAWINGS

FIG. 1 is a schematic diagram of a vendor machine in the prior art;

FIG. 2 is a schematic diagram of a vendor machine according to the first preferred embodiment of the present invention;

FIG. 3 is a schematic diagram of a vendor machine according to the second preferred embodiment of the present invention;

FIG. 4(a) is a first waveform diagram of the price versus time of a vendor machine according to the first and the second preferred embodiments of the present invention;

FIG. 4(b) is a second waveform diagram of the price versus time of a vendor machine according to the first and the second preferred embodiments of the present invention;

FIG. 4(c) is a third waveform diagram of the price versus amount of a vendor machine according to the first and the second preferred embodiments of the present invention; and

FIG. 5 is a schematic diagram of a fare display of a parking lot according to the third preferred embodiment of the present invention.

### DETAILED DESCRIPTION OF THE PREFERRED EMBODIMENT

The present invention provides a price display apparatus including a bistable display panel displaying a selling price of an item for sale, and the bistable display panel is one selected from a group consisting of an electrophoresis display, an MEMS display, a cholesteric display and an electrowetting display. The price display apparatus is, e.g., one of a vendor machine and a fare display of a parking lot.

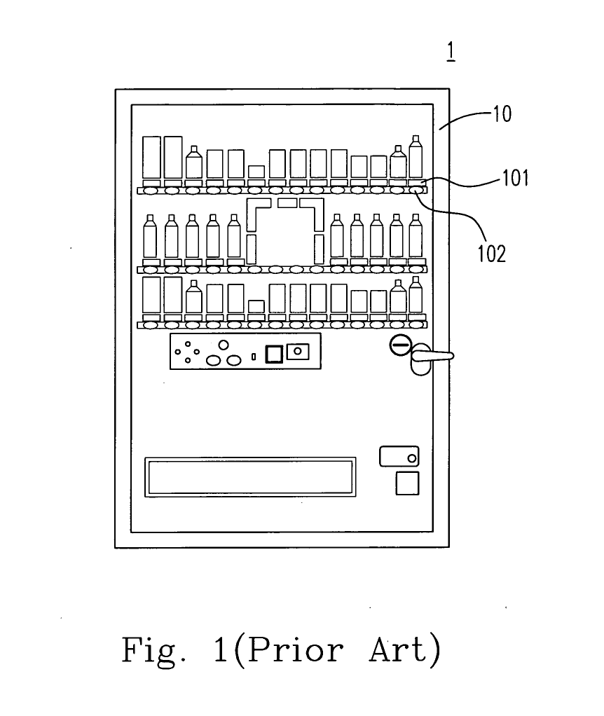

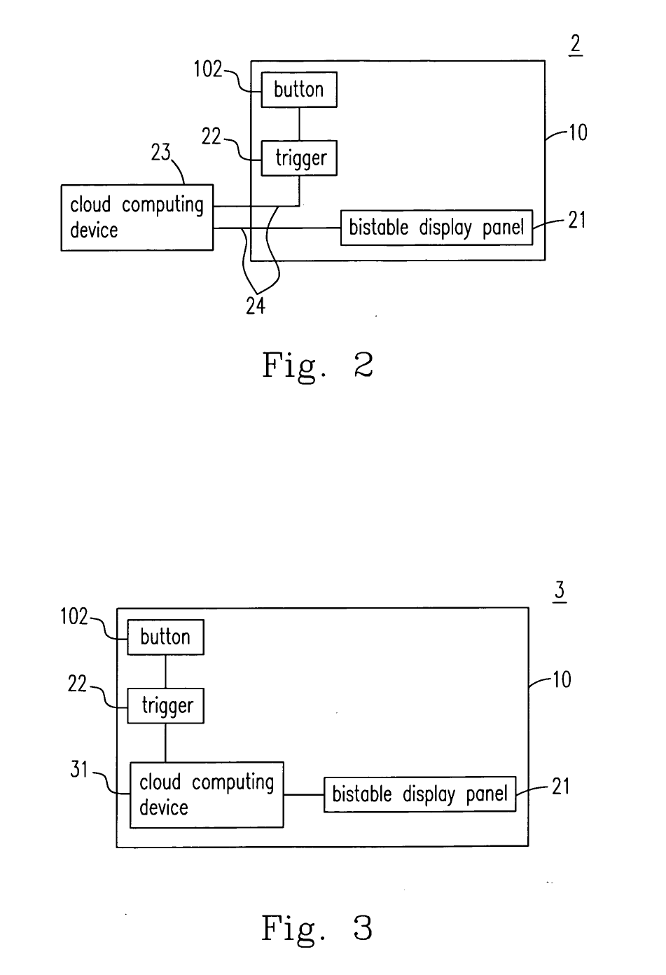

FIG. 2 is a schematic diagram of a vendor machine according to the first preferred embodiment of the present invention. The vendor machine 2 includes not only the vendor machine main body 10 and the button 102 as shown in FIG. 1 but also a bistable display panel 21, a trigger 22, a cloud computing device 23 and an interne 24.

FIG. 3 is a schematic diagram of a vendor machine according to the second preferred embodiment of the present invention. The vendor machine 3 includes not only the vendor machine main body 10 and the button 102 as shown in FIG. 1 but also a bistable display panel 21, a trigger 22 and a built-in computing device 31.

As shown in FIGS. 2 and 3, the vendor machine 2/3 includes a computing device being one of a cloud computing device 23 and a built-in computing device 31 and coupled to the bistable display panel 21 so as to decide which one of a peak value and a non-peak value should be displayed as the selling price, wherein the displayed selling price is the peak value when a selling amount in a specific period is larger than a predetermined value and the displayed selling price is the non-peak value when the selling amount in the specific period is not larger than the predetermined value. The trigger 22 sends out a trigger signal to the (cloud/built-in) computing device 23/31 to increase the selling amount by one when a user buys the item and pushes down the button 102. As shown in FIG. 2, the cloud computing device 31 and the bistable panel 21 are transmitting an information therebetween via the internet 24. In FIG. 3, the built-in computing device 31 is configured in the vender machine 3.

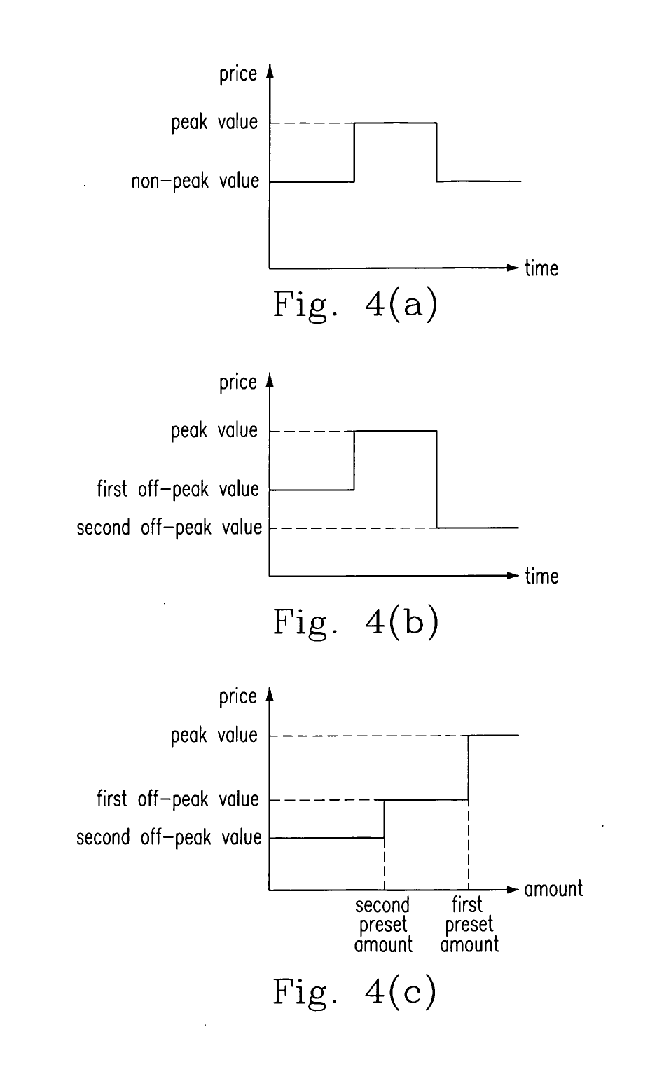

FIG. 4(a) is a first waveform diagram of the price versus time of a vendor machine according to the first and the second preferred embodiments of the present invention, wherein the peak value is larger than the non-peak value (certainly, the peak value can be smaller than the non-peak value in another preferred embodiment of the present invention, which is not shown).

FIG. 4(b) is a second waveform diagram of the price versus time of a vendor machine according to the first and the second preferred embodiments of the present invention, wherein the non-peak value includes a first off-peak value and a second off-peak value.

FIG. 4(c) is a third waveform diagram of the price versus amount of a vendor machine according to the first and the second preferred embodiments of the present invention. The predetermined value includes a first preset amount and a second preset amount, the non-peak value is the first off-peak value when the selling amount is smaller than the first preset amount and is larger than the second preset amount, and the non-peak value is the second off-peak value when the selling amount is not larger than the second preset amount.

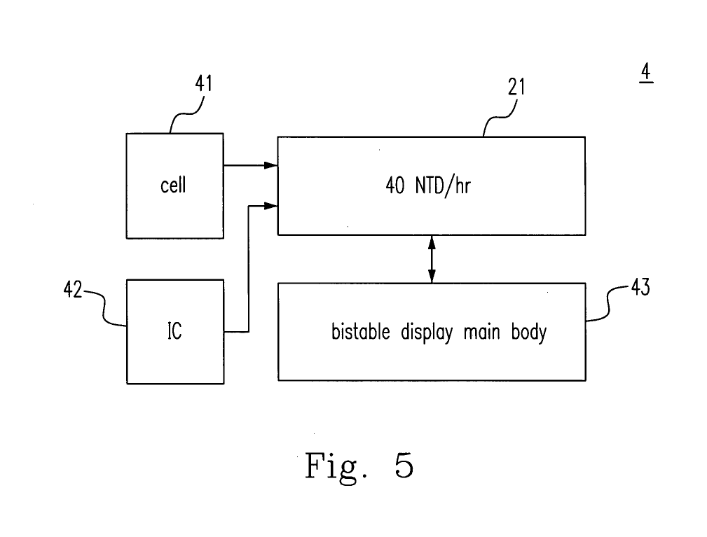

As aforementioned, the price display apparatus is one of a fare display of a parking lot and a vendor machine 2/3. The selling price is one of an ordinary selling price and a special selling price, the panel 21 is configured to display the ordinary selling price during a period of an ordinary time and the special selling price during a specific time period, and the ordinary selling price, the special selling price, the period of the ordinary time and the specific time period are all predetermined. FIG. 5 is a schematic diagram of a fare display of a parking lot according to the third preferred embodiment of the present invention. As shown in FIG. 5, the fare display of the parking lot 4 includes a bistable display panel 21 (e.g., the panel shows a fare of 40 NTD/hr) including a cell 41 and a chip (IC) 42, and a bistable display main body 43. The ordinary selling price and the special selling price of the fare display 4 are respectively an ordinary fare and a specific fare and the ordinary selling price and the special selling price of the vendor machine 2/3 are respectively a non-peak value and a peak value. The chip 42 is used to store the ordinary selling price, the special selling price, the period of the ordinary time and the specific time period, and the cell 41 is user to provide a power source to the panel 21.

As above-mentioned, the price display apparatus is one of a vendor 2/3 and a fare display of a parking lot 4, both of which include a display panel displaying one of a first price under a first status and a second price under a second status, for an item, wherein the display panel is a bistable display panel 21. When the price display apparatus is the fare display of the parking lot 4, the item is a parking space, the first status is during a period of an ordinary time, the first price is an ordinary fare, the second status is during a specific time period, and the second price is a special fare. When the price display apparatus is the vendor machine 2/3, the first status is referring to a first opportunity when a selling amount of the item is not larger than a predetermined value during a first specific period, the first price is a non-peak value, the second status is referring to a second opportunity when a selling amount of the item is larger than a predetermined value during a second specific period, and the second price is a peak value.

The present invention also provides a method for displaying a price of an item including steps of: displaying a peak value of the price when a selling amount of the item during a specific period is larger than a predetermined value; and displaying a non-peak value of the price when the selling amount is not larger than the predetermined value. The price is displayed on an apparatus including a bistable display panel 21, wherein the apparatus is a vendor machine 2/3, and the vendor machine 2/3 includes a computing device 23/31, a trigger 22 and a button 102. The method further includes a step of increasing the selling amount by one when the button 102 is pushed down by a user so as to send out a trigger signal from the trigger 22 to the computing device 23/31.

### Embodiments

1. A price display apparatus, including a bistable display panel displaying a selling price of an item.

2. An apparatus according to embodiment 1, wherein the bistable display panel is one selected from a group consisting of an electrophoresis display, an MEMS display, a cholesteric LCD and an electrowetting display.

3. An apparatus according to embodiment 1 or 2 being a vendor machine further including a computing device coupled to the bistable display panel so as to decide which one of a peak value and a non-peak value should be displayed as the selling price, wherein the displayed selling price is the peak value when a selling amount in a specific period is larger than a predetermined value and the displayed selling price is the non-peak value when the selling amount in the specific period is not larger than the predetermined value.

4. An apparatus according to any one of embodiments 1 to 3, wherein the vendor machine further includes a trigger and a button, the trigger sends out a trigger signal to the computing device to increase the selling amount by one when a user buys the item and pushes down the button, the computing device is one of a built-in computing device and a cloud computing device, the cloud computing device and the bistable panel are transmitting an information therebetween via an internet, and the built-in computing device is configured in the vender machine.

5. An apparatus according to any one of embodiments 1 to 4, wherein the peak value is larger than the non-peak value, the non-peak value includes a first off-peak value and a second off-peak value, the predetermined value includes a first preset amount and a second preset amount, the non-peak value is the first off-peak value when the selling amount is smaller than the first preset amount and is larger than the second preset amount, and the non-peak value is the second off-peak value when the selling amount is not larger than the second preset amount.

6. An apparatus according to any one of embodiments 1 to 5, wherein the selling price is one of an ordinary selling price and a special selling price, the panel is configured to display the ordinary selling price during a period of an ordinary time and the special selling price during a specific time period, and the ordinary selling price, the special selling price, the period of the ordinary time and the specific time period are all predetermined.

7. An apparatus according to any one of embodiments 1 to 6 being one of a fare display of a parking lot and a vendor machine, wherein the ordinary selling price and the special selling price of the fare display are respectively an ordinary fare and a specific fare and the ordinary selling price and the special selling price of the vendor machine are respectively a non-peak value and a peak value.

8. An apparatus according to any one of embodiments 1 to 7, wherein the panel of the fare display includes a cell and a chip, the chip is used to store the ordinary selling price, the special selling price, the period of the ordinary time and the specific time period, and the cell is user to provide a power source to the panel.

9. A price display apparatus, including a display panel displaying one of a first price under a first status and a second price under a second status, for an item.

10. An apparatus according to embodiment 9 being a fare display of a parking lot, wherein the display panel is a bistable display panel, the item is a parking space, the first status is during a period of an ordinary time, the first price is an ordinary, fare, the second status is during a specific time period, and the second price is a special fare.

11. An apparatus according to embodiment 9 or 10 being a vendor machine, wherein the display panel is a bistable display panel, the first status is referring to a first opportunity when a selling amount of the item is not larger than a predetermined value during a first specific period, the first price is a non-peak value, the second status is referring to a second opportunity when a selling amount of the item is larger than a predetermined value during a second specific period, and the second price is a peak value.

12. A method for displaying a price of an item, including steps of: displaying a peak value of the price when a selling amount of the item during a specific period is larger than a predetermined value; and displaying a non-peak value of the price when the selling amount is not larger than the predetermined value.

13. A method according to embodiment 12, wherein the price is displayed on an apparatus including a bistable display panel.

14. A method according to embodiment 12 or 13, wherein the apparatus is a vendor machine including a computing device, a trigger and a button.

15. A method according to any one of embodiments 12 to 14 further including a step of increasing the selling amount by one when the button is pushed down by a user buying the item so as to send out a trigger signal from the trigger to the computing device.

According to the aforementioned descriptions, the present invention provides a price display apparatus having a bistable display panel, displaying one of a first selling price at a first selling status and a second selling price at a second selling status, possessing a multi-advantage and being quite convenient so as to possess the non-obviousness and the novelty.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A price display apparatus, comprising a bistable display panel displaying a selling price of an item.

2. An apparatus according to claim 1, wherein the bistable display panel is one selected from a group consisting of an electrophoresis display, an MEMS display, a cholesteric LCD and an electrowetting display.

3. An apparatus according to claim 1 being a vendor machine further comprising a computing device coupled to the bistable display panel so as to decide which one of a peak value and a non-peak value should be displayed as the selling price, wherein the displayed selling price is the peak value when a selling amount in a specific period is larger than a predetermined value and the displayed selling price is the non-peak value when the selling amount in the specific period is not larger than the predetermined value.

4. An apparatus according to claim 3, wherein the vendor machine further comprises a trigger and a button, the trigger sends out a trigger signal to the computing device to increase the selling amount by one when a user buys the item and pushes down the button, the computing device is one of a built-in computing device and a cloud computing device, the cloud computing device and the bistable panel are transmitting an information therebetween via an internet, and the built-in computing device is configured in the vender machine.

5. An apparatus according to claim 3, wherein the peak value is larger than the non-peak value, the non-peak value comprises a first off-peak value and a second off-peak value, the predetermined value comprises a first preset amount and a second preset amount, the non-peak value is the first off-peak value when the selling amount is smaller than the first preset amount and is larger than the second preset amount, and the non-peak value is the second off-peak value when the selling amount is not larger than the second preset amount.

6. An apparatus according to claim 1, wherein the selling price is one of an ordinary selling price and a special selling price, the panel is configured to display the ordinary selling price during a period of an ordinary time and the special selling price during a specific time period, and the ordinary selling price, the special selling price, the period of the ordinary time and the specific time period are all predetermined.

7. An apparatus according to claim 6 being one of a fare display of a parking lot and a vendor machine, wherein the ordinary selling price and the special selling price of the fare display are respectively an ordinary fare and a specific fare and the ordinary selling price and the special selling price of the vendor machine are respectively a non-peak value and a peak value.

8. An apparatus according to claim 7, wherein the panel of the fare display comprises a cell and a chip, the chip is used to store the ordinary selling price, the special selling price, the period of the ordinary time and the specific time period, and the cell is user to provide a power source to the panel.

9. A price display apparatus, comprising a display panel displaying one of a first price under a first status and a second price under a second status, for an item.

10. An apparatus according to claim 9 being a fare display of a parking lot, wherein the display panel is a bistable display panel, the item is a parking space, the first status is during a period of an ordinary time, the first price is an ordinary fare, the second status is during a specific time period, and the second price is a special fare.

11. An apparatus according to claim 9 being a vendor machine, wherein the display panel is a bistable display panel, the first status is referring to a first opportunity when a selling amount of the item is not larger than a predetermined value during a first specific period, the first price is a non-peak value, the second status is referring to a second opportunity when a selling amount of the item is larger than a predetermined value during a second specific period, and the second price is a peak value.

12. A method for displaying a price of an item, comprising steps of:
displaying a peak value of the price when a selling amount of the item during a specific period is larger than a predetermined value; and
displaying a non-peak value of the price when the selling amount is not larger than the predetermined value.

13. A method according to claim 12, wherein the price is displayed on an apparatus comprising a bistable display panel.

14. A method according to claim 13, wherein the apparatus is a vendor machine comprising a computing device, a trigger and a button.

15. A method according to claim 14 further comprising a step of increasing the selling amount by one when the button is pushed down by a user buying the item so as to send out a trigger signal from the trigger to the computing device.
